(19) United States
(12) Patent Application Publication
(10) Pub. No.: US 2006/0146369 A1
(43) Pub. Date: Jul. 6, 2006

(54) Printing apparatus and printing method

(75) Inventor: Toshio Matsubara, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/320,597

(22) Filed: Dec. 30, 2005

(30) Foreign Application Priority Data
Jan. 6, 2005 (JP) 2005-001470

(51) Int. Cl. G06K 15/00

(52) U.S. Cl. 358/1.18; 358/1.12

(57) ABSTRACT

The present invention provides a printing apparatus and a method for a user to easily obtain an image print without accompanying information if the user needs no accompanying information even if the image is already embedded with various types of accompanying information such as date of taking the picture and the like. The printing apparatus comprises: a detecting section for detecting accompanying information accompanying an image; a trimming section for determining a trimming region which does not include the accompanying information and cutting an image included in the trimming region out from the region; and a printing section for printing the cut out image. The printing method comprises the steps of: detecting accompanying information which accompanies an image; determining a trimming region which does not include the accompanying information and cutting an image included in the trimming region out from the region; and printing the cut out image.

### BACKGROUND OF THE INVENTION

1. Field of the Invention

The present invention relates to a printing apparatus and a printing method, and specifically to a technique for printing information accompanying an image.

2. Description of the Related Art

As techniques for adding date information to digital image data, techniques are disclosed in Japanese Patent Application Laid-Open No. 2002-16789 and Japanese Patent Application Laid-Open No. 2001-61089 shown below. In Patent Japanese Patent Application Laid-Open No. 2002-16789, an image taken by a digital camera is recorded in an image file in the Exif file format. The Exif file includes data of a primary image (main image) and additional information relating to the primary image. The additional information includes information on date and time of taking the picture and information for identifying the model of the camera (for example, information on the manufacturer of Exif, the model name and the like). The additional information is written in the header part of the file.

In Japanese Patent Application Laid-Open No. 2001-61089, image data taken by a CCD is combined with information on date of taking the picture and a street address. The combined data is sent to a printer control circuit as data for printing. The combined data can be saved in a memory card.

In Japanese Patent Application Laid-Open No. 2004-7100, a character string image generated by a character string image generation circuit is embedded in an RGB image generated by a color interpolation RGB image generation circuit at an image combining circuit. Then, the combined image data outputted from the image combining circuit is compressed at an image compressing circuit and stores the compressed data in memory. The RGB image, in which the character string image will be embedded, among the RGB image generated by the color interpolation RGB image generation circuit is compressed by an image for restoring the original image compressing circuit as an image for restoring the original image. Then the data of compressed image for restoring the original image outputted from the image for restoring the original image compressing circuit is encrypted at an encrypting circuit and the encrypted data is stored in memory. In this manner, an original image can be easily restored without requiring the original image to be saved, even if a character string image such as date of taking a picture is embedded in the original image by a digital camera or the like.

### SUMMARY OF THE INVENTION

As a method for printing an image added with date information, a printing system reads date information in an Exif file and combines an image with the date information, as disclosed in Patent Japanese Patent Application Laid-Open No. 2002-16789. If a person does not want to add the date information to the image, the image and the date information are not combined. If date information is combined with an actual image data at a digital camera as disclosed in Japanese Patent Application Laid-Open No. 2001-61089, the date is printed even if a person does not want to add the date information to the image.

Another method can be as disclosed in Japanese Patent Application Laid-Open No. 2004-7100 for restoring the original image as required such as when date information is not needed. In this method, however, data for restoring the original image need to be stored separately and this requires extra storage to be reserved. Moreover, although the storing scheme of an original image and the restoring scheme of an original image need to be the same, the scheme varies among manufactures of a digital camera. Thus, it is difficult for a single printing apparatus to restore the original image taken by any manufactures' digital camera.

The present invention is adapted in view of the abovementioned problems, and intends to provide a printing apparatus and a printing method for a user to easily obtain an image print without accompanying information if the user needs no accompanying information even if the image is already embedded with various types of accompanying information such as date of taking the picture and the like.

In order to solve the abovementioned problems, a printing apparatus according to the present invention includes: a detecting section for detecting accompanying information which accompanies an image; a trimming section for determining a trimming region which does not include the accompanying information and cutting an image included in the trimming region out from the region; and a printing section for printing the cut out image.

With the present invention, an image included in the trimming region which does not include accompanying information is cut out and printed so that the accompanying information is not printed as required. The accompanying information can be embedded in the actual image or recorded in a header part of an image file as tag information.

The printing apparatus may further includes an operating section for accepting selection of whether or not to print the accompanying information. The trimming section cuts out the image when selection of not printing the accompanying information is accepted.

In this manner, a user can freely select whether or not to print accompanying information as required.

The printing apparatus may further includes a composite section for combining the accompanying information with a print region in response to the accompanying information placed outside a print region of the printing section, when selection of printing the accompanying information is accepted.

In this manner, the accompanying information can be combined in the print region and printed as required, even if the accompanying information is not embedded in the image.

The trimming section may determine the trimming region so that the area of an image part included in the trimming region is the biggest.

The trimming section may determine the trimming region so that the vertical length and the horizontal length of the image part which is not included in the trimming region are equal.

In this manner, it is preferable that the center of the object is not moved by trimming.

A printing method according to the present invention includes the steps of: detecting accompanying information which accompanies an image; determining a trimming region which does not include the accompanying information and cutting an image included in the trimming region out from the region; and printing the cut out image.

With the present invention, a user can prevent accompanying information from being printed as required, as an image included in a trimming region which does not include accompanying information is cut out and printed.

### BRIEF DESCRIPTION OF THE DRAWINGS

FIG. 1 is a functional block diagram of a printing apparatus according to a preferred embodiment of the present invention;

FIG. 2 is a flowchart showing a flow of printing process;

FIG. 3 is a flowchart showing a flow of printing process;

FIG. 4A is a diagram, showing an example of a trimming region which does not include accompanying information;

FIG. 4B is a diagram, showing an example of a trimming region which does not include accompanying information;

FIG. 5 is a diagram showing an example of trimming region which does not include accompanying information and in which the vertical length and the horizontal blank length are equal;

FIG. 6 is a diagram showing an example of a print which does not include accompanying information;

FIG. 7 is a diagram showing an example of accompanying information, which is entirely included in the print region;

FIG. 8 is a diagram showing an example of accompanying information, a part of which is included in the print region;

FIG. 9 is a diagram showing an example of accompanying information, which is entirely excluded from the print region;

FIG. 10 is a diagram showing an example of accompanying information combined in the print region; and

FIG. 11 is a diagram showing an example of a print, in which accompanying information is combined.

### DETAILED DESCRIPTION OF THE PREFERRED EMBODIMENTS

A preferred embodiment of the present invention will be described with reference to accompanying drawings.

<First Embodiment>

[Outline]

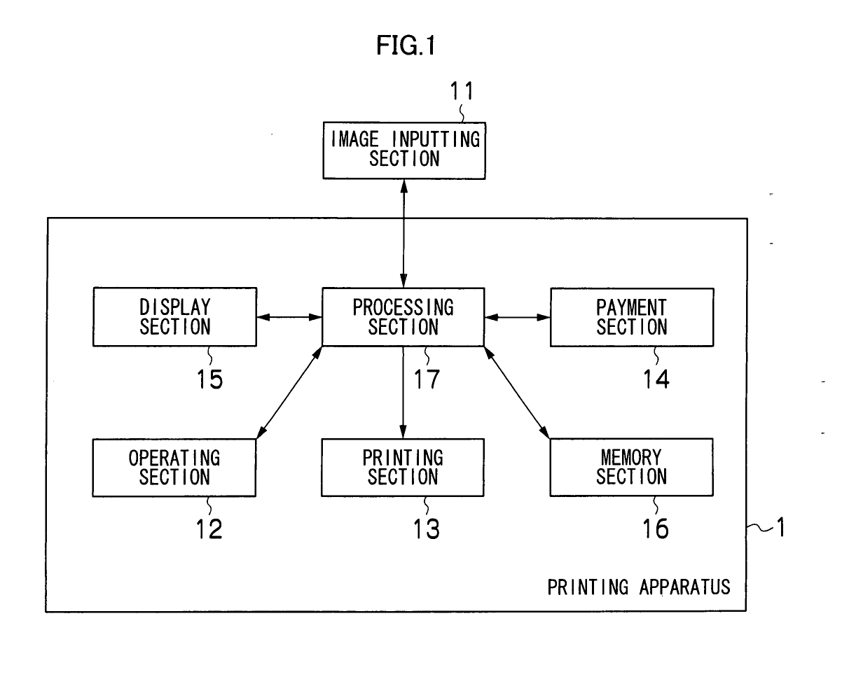

FIG. 1 is a block diagram showing a configuration of a printing apparatus 1 according to a preferred embodiment of the present invention. The printing apparatus 1 includes an image inputting section 11 for inputting image data from an image reading unit, which reads an image from a recording medium such as a smart medium (Solid-State Floppy Disk Card), a PC card, a compact flash (Registered Trademark), a magnetic disk, an optical disk, a magneto-optical disk, a memory stick or the like, an operating section 12 consisting of operation buttons, a touch panel and the like for accepting an operational input from a user, a printing section 13 for making a printing, a payment section 14 for settling an account for a printing, a display section 15 consisting of a liquid crystal display or the like, a memory section 16 for storing data and a program required for calculation as well as accompanying information such as a frame and the like, and a processing section 17 for performing the control over various sections and the various types of calculation.

An image can be inputted from various types of image inputting unit such as a flatbed scanner or the like into the image inputting section 11. An image recorded on a silver-salt film can also be treated as image data read from a recording medium, if only the image is converted into digital image data by a scanner.

The display section 15 displays what in accordance with a direction from the processing section 17. A user inputs setting items including selection of an image to print, the number to print, and the type of print from the operating section 12 through a graphical user interface (GUI) displayed on the display section 15. As the type of print, a print size, whether or not to print a multi-screen print, an output form of an accompanying image and a form of a postcard print can be designated. The print size can be selected from <post card/size L/size 2L/16-split peel-off sticker/4-split peel-off sticker>. The multi-screen print can be designated by the number of splits of the screen from <16/4/2/None>. An output form of an accompanying image can be designated from <separate sheet/2-split screen>. A form of a post card print can be designated from <backside of a post card image/envelope/label sealing>. The setting items inputted from the operating section 12 will be referred to as ordering information hereinafter. The memory section 16 stores a unit price of a print corresponding to each type of print. The unit price is set in yen unit in this embodiment.

The processing section 17 generates image data for printing in accordance with image data and ordering information in response to a predetermined amount of money dropped into the payment section 14. The image data for printing will be referred as print data and process for creating the print data will be referred to as print data process. The print data is sent to the printing section 13, and then the printing section 13 executes printing operation and outputs a printing. The printing scheme is not limited to particular schemes, and can include various schemes such as the thermo autochrome (TA) scheme, in which heat changes the color on a sheet of photographic paper, and the ink-jet scheme, in which ink is sprayed onto a sheet of photographic paper through a jet.

The image data to be inputted into the image inputting section 11 is a JPEG file or a TIFF file, in which various types of accompanying information of an image such as date or a condition of taking a picture are embedded in the image, as well as the Exif (Exchangeable Image File Format) file which records the accompanying information on the tag, and may be in any image-recording-form.

[Flow of Process]

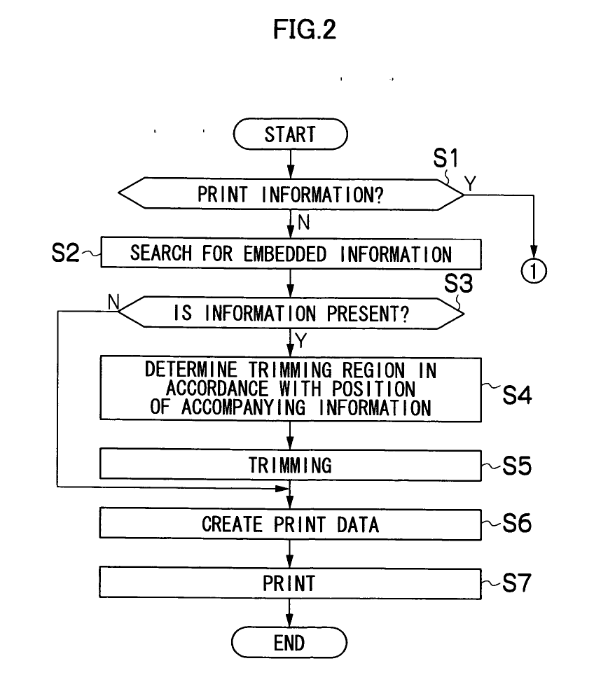

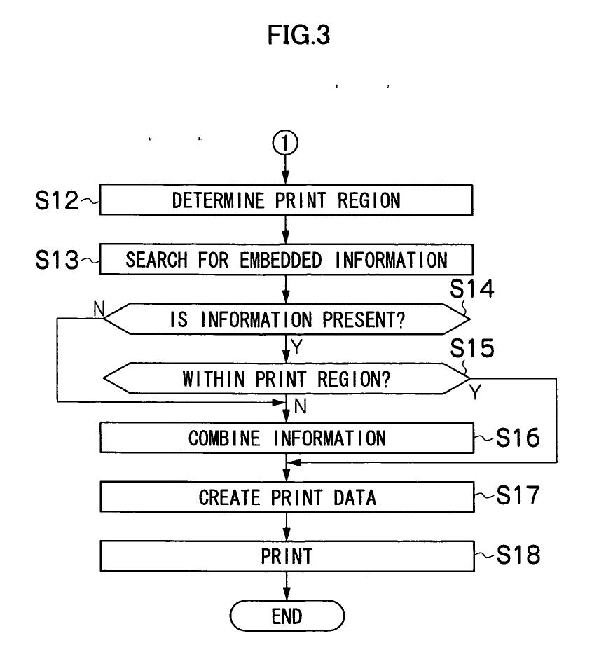

Now, printing process executed by the processing section 17 will be described with reference to flowcharts of FIGS. 2 and 3.

At S1, selection whether or not to print accompanying information is accepted from the operating section 12. When selection of not printing the accompanying information is accepted, operation proceeds to S2. When selection of printing the accompanying information is accepted, operation proceeds to S12. Process after S12 will be described later.

At S2, the image is searched for the accompanying information embedded in image data inputted in the image inputting section 11. As a method for searching the accompanying information embedded in the image, a method of determining whether color variations detected in a certain objective pixel region (top, bottom, left and right margins of an image) and a shape of a pixel with color variations match reference information stored in the memory section 16 (such as a character string representing a certain date) can be considered. The position of the detected accompanying information is stored in the memory section 16.

At S3, whether the accompanying information is detected or not is determined. If the accompanying information is detected, operation proceeds to S4. If the accompanying information is not detected, operation proceeds to S6.

At S4, a trimming region of an image is determined so that the accompanying information is not included in the printable region of the printing section 13 in accordance with the position of the accompanying information stored in the memory section 16. A user can determine the trimming region by changing coordinate parameters P1, P2 of two diagonal points of the rectangle. In order to make an image cut out by trimming as big as possible, the trimming region is preferably determined so that the area of an image part included in the trimming region is as big as possible. A trimming frame, which is an outer edge of the trimming region, can be displayed with the image on the display section 15.

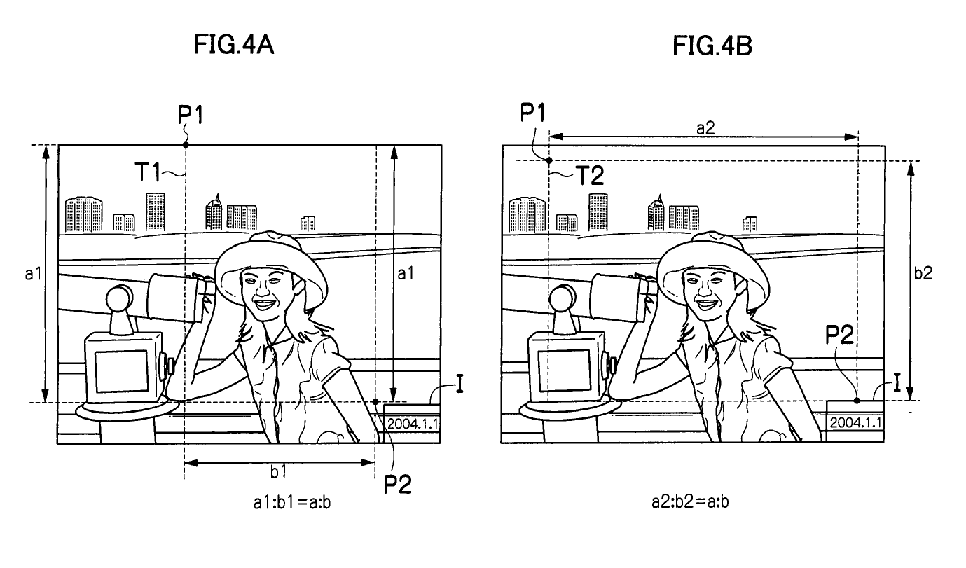

FIGS. 4A and 4B show a certain image with accompanying information I embedded in the image. An aspect ratio a1:b1 of a trimming region T1 in FIG. 4A and an aspect ratio a2:b2 of a trimming region T2 of FIG. 4B are the same as an aspect ratio a:b of the printable region. Neither of the trimming regions includes the accompanying information I. The area of the trimming region T1 a1×b1 is smaller than the area of the trimming region T2 a2×b2. T1 is not preferable because a region of an object to be actually printed is too small. Therefore, it is preferable to determine the trimming region T2, in which the area including the object is the biggest, as the final trimming region.

So as not to move the center of the object after trimming, it is preferable to make the vertical length and the horizontal length of the image part equal, which is not included in the trimming region.

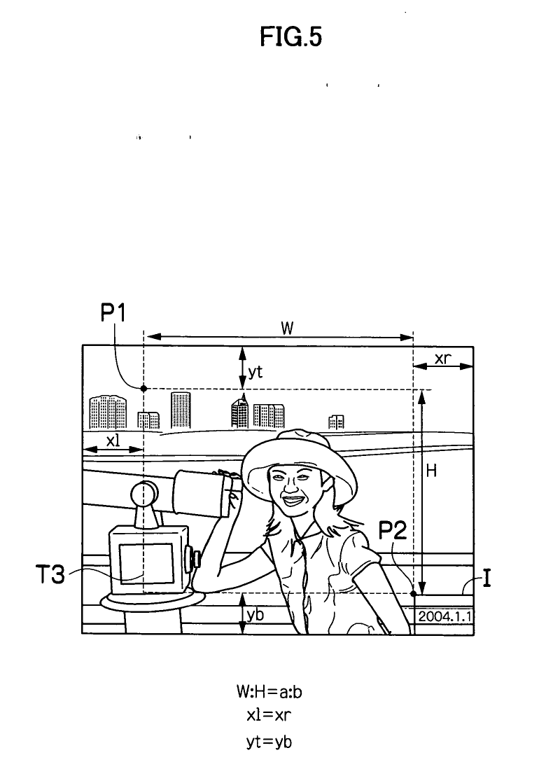

For example, as shown in FIG. 5, an aspect ratio of width and height W:H of the trimming region T3 is the same as an aspect ratio a:b of the print region. The length of the top margin yt and the length of the bottom margin yb, which are not included in the trimming region T3, are the same. The length of the left margin x1 and the length of the right margin xr are the same. In the trimming region T3 set as such, the center of the object before trimming is unchanged after the trimming. Therefore, the present invention is preferable as balance of top, down, left and right position of an object is kept even after trimming.

At S5, an image included in the determined trimming region is cut out (trimming).

At S6, print data of an image, for which no accompanying information is detected, or print data of a cut but image is generated and sent to the printing section 13.

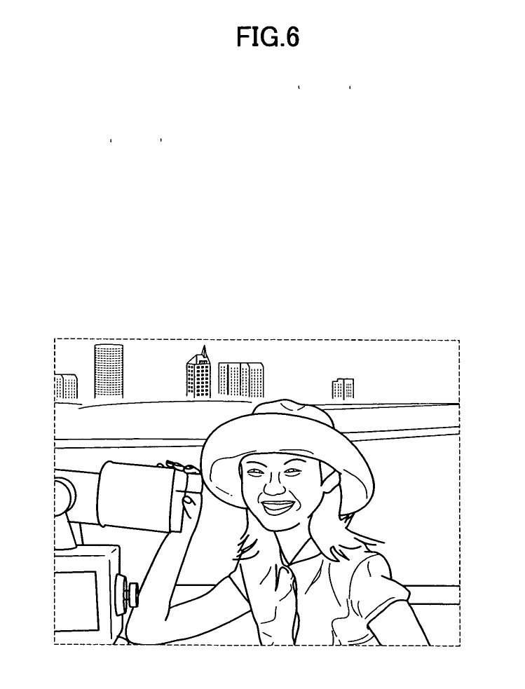

At S7, the image is printed in accordance with the print data. FIG. 6 shows a result of printing an image which is trimmed so as not to include accompanying information (see FIG. 5).

FIG. 3 is a flowchart showing process after S11.

At S12, a print region of an image is determined in accordance with a printable region of the printing section 13. The aspect ratio of width and height of the print region has to match at least the aspect ratio of width and height of the printable region. Similar to the abovementioned determination of a trimming region, the print region is preferably determined so that the area of an image part included in the print region is the biggest or the vertical length and the horizontal length of an image part, which is not included in the print region, are equal.

At S13, image data inputted into the image inputting section 11 is searched for accompanying information embedded in the image as in S2. The detected accompanying information and the position are stored in the memory section 16.

At S14, whether the accompanying information is detected or not is determined. If the accompanying information is detected, operation proceeds to S15. If the accompanying information is not detected, operation proceeds to S16.

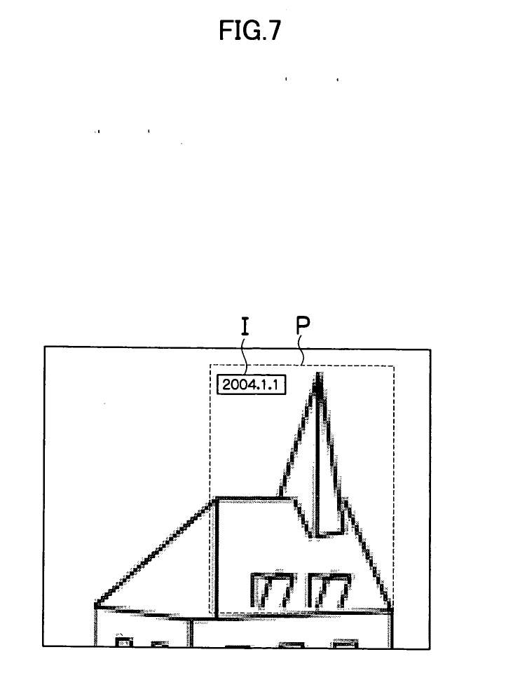

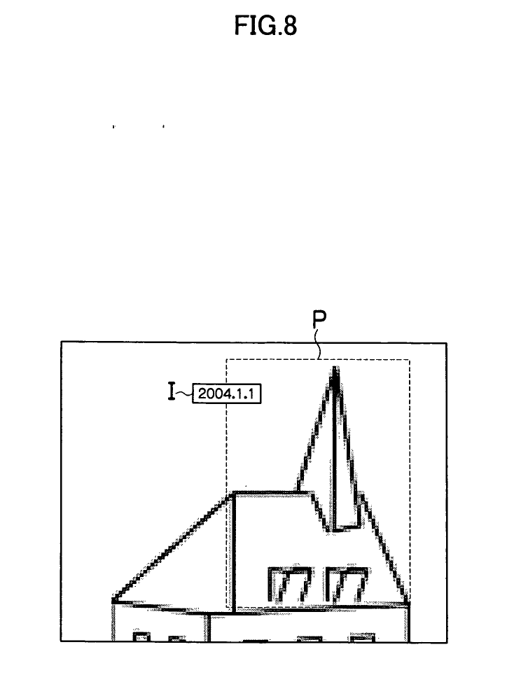

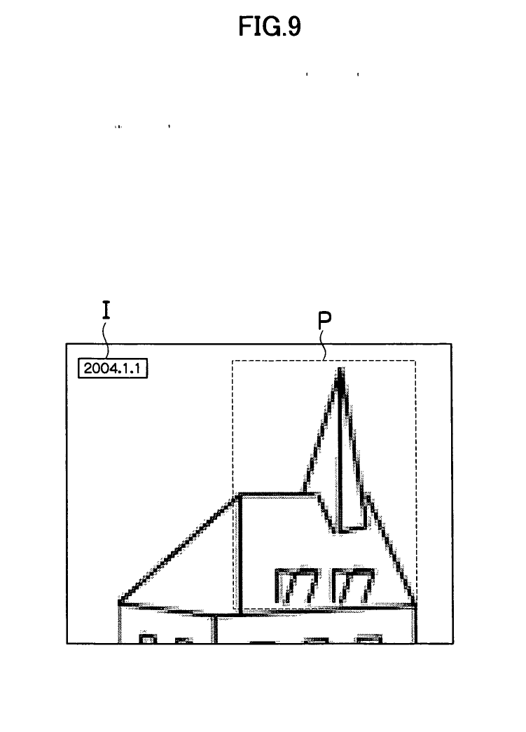

At S15, whether the entire of the accompanying information is included in the print region or not is determined with reference to the position of the accompanying information. If the entire of the accompanying information is included in the print region, operation proceeds to S17. If a part of the accompanying information is not included in the print region, operation proceeds to S16. FIG. 7 shows an image, in which the entire of accompanying information I is included in the print region P. Each of FIGS. 8 and 9 shows an image, in which a part or the entire of the accompanying information I is not included in a print region P, i.e., an image with accompanying information I being positioned outside the print region P.

At S12, it is preferable to determine the print region so that the entire of the accompanying information I is placed outside the print region P or the entire of the accompanying information I is included in the print region P to prevent a part of the accompanying information I from being included in the print region P as shown in FIG. 8.

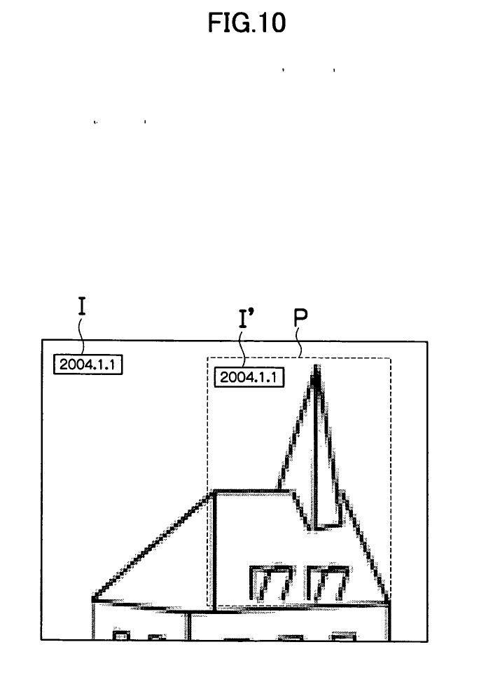

At S16, the accompanying information is read from a header part of an image file (for example, a predetermined tag of an Exif file), and an image combined with the read accompanying information combined in the print region is created. FIG. 10 shows an example of a combination of an image, in which the entire of the accompanying information I is not included in a print region (see FIG. 9), and accompanying information I′ within the print region. Accompanying information (image name, date, condition of taking a picture, manufacturer of the camera, or the like) may be designated through the operating section 12 to be combined with the image. The accompanying information to be combined with an image may be a part or the entire of the accompanying information stored in a header part of an image file or may be read from the memory section 16.

At S17, print data of an image, in which accompanying information is included in the print region, or print data of an image, in which accompanying information is combined within the print region is created.

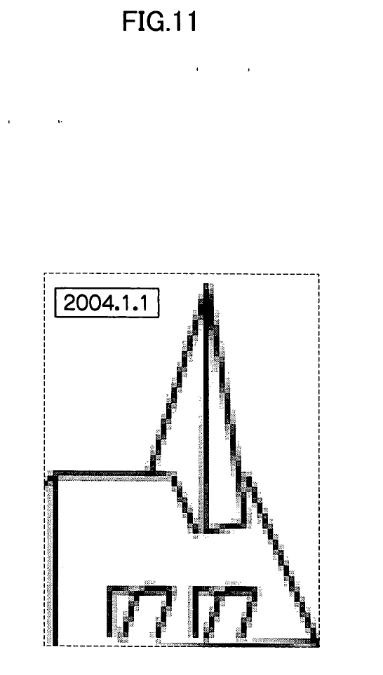

At S18, the image is printed in accordance with the print data. FIG. 11 shows a result of printing an image, in which accompanying information is combined in the print region.

As mentioned above, the printing apparatus 1 prints an image by removing accompanying information from the print region if selection of not printing the accompanying information is done. If selection of printing the accompanying information is done, the accompanying information embedded in the image is printed as it is. If the accompanying information embedded in an image is not included in a print region, the accompanying information read from a header part of an image file or the memory section 16 is combined in the print region and printed. Whether the accompanying information is embedded in an image or not, the present invention is adapted to print or not print the accompanying information as required.

If the entire of the accompanying information is included in a print region (“Y” at S15), the print apparatus 1 does not combine the accompanying information. That is to say, the present invention can prevent accompanying information from redundantly embedded in an image, as the entire of the accompanying information is already included in the print region.

What is claimed is:

1. A printing apparatus comprising:
a detecting section for detecting accompanying information accompanying an image;
a trimming section for determining a trimming region which does not include the accompanying information and cutting an image included in the trimming region out from the region; and
a printing section for printing the cut out image.

2. The printing apparatus according to claim 1, further comprising an operating section for accepting selection of whether or not to print the accompanying information,
wherein the trimming section cuts out the image when selection of not printing the accompanying information is accepted.

3. The printing apparatus according to claim 2, further comprising a composite section for combining the accompanying information with a print region in response to the accompanying information placed outside the print region of the printing section, when selection of printing the accompanying information is accepted.

4. The printing apparatus according to claim 1, wherein the trimming section determines the trimming region so that the area of an image part included in the trimming region is the biggest.

5. The printing apparatus according to claim 2, wherein the trimming section determines the trimming region so that the area of an image part included in the trimming region is the biggest.

6. The printing apparatus according to claim 3, wherein the trimming section determines the trimming region so that the area of an image part included in the trimming region is the biggest.

7. The printing apparatus according to claim 1, wherein the trimming section determines the trimming region so that the vertical length and the horizontal length of the image part which is not included in the trimming region are equal.

8. The printing apparatus according to claim 2, wherein the trimming section determines the trimming region so that the vertical length and the horizontal length of the image part which is not included in the trimming region are equal.

9. The printing apparatus according to claim 3, wherein the trimming section determines the trimming region so that the vertical length and the horizontal length of the image part which is not included in the trimming region are equal.

10. The printing apparatus according to claim 4, wherein the trimming section determines the trimming region so that the vertical length and the horizontal length of the image part which is not included in the trimming region are equal.

11. The printing apparatus according to claim 5, wherein the trimming section determines the trimming region so that the vertical length and the horizontal length of the image part which is not included in the trimming region are equal.

12. The printing apparatus according to claim 6, wherein the trimming section determines the trimming region so that the vertical length and the horizontal length of the image part which is not included in the trimming region are equal.

13. A printing method comprising the steps of:
detecting accompanying information which accompanies an image;
determining a trimming region which does not include the accompanying information and cutting an image included in the trimming region out from the region; and
printing the cut out image.
